(19) United States
(12) Patent Application Publication
(10) Pub. No.: US 2023/0251211 A1
(43) Pub. Date: Aug. 10, 2023

(54) METHOD AND DEVICE FOR INSPECTING AN OBJECT

(71) Applicant: SACMI COOPERATIVA MECCANICI IMOLA SOCIET A'COOPERATIVA, Imota(Bologna) (IT)

(72) Inventors: Massimo BALDUCCI, Imola (Bologna) (IT); Fabrizio PUCCI, Castelguelfo (Bologna) (IT); Fiorenzo PARRINELLO, Medicina (Bologna) (IT)

(21) Appl. No.: 17/999,360

(22) PCT Filed: May 20, 2021
(86) PCT No.: PCT/IB2021/054377

§ 371 Date: Nov. 18, 2022

(30) Foreign Application Priority Data
May 21, 2020 (IT) 102020000011950

(51) Int. Cl. G01N 23/087; G01N 23/16

(52) U.S. Cl. CPC G01N 23/087; G01N 23/16

(57) ABSTRACT

A method for inspecting an object made of plastic material and including at least one layer to be inspected, comprises the following steps: positioning the object in an inspection zone (Z); irradiating the inspection zone (Z) with electromagnetic radiation emitted by an emitter (2); detecting, with a 5 sensor (3), an absorption of the electromagnetic radiation by the layer to be inspected and accordingly generating an absorption signal (301) representing the absorption of the electromagnetic radiation by the layer to be inspected; processing the absorption signal (301) in a control unit (6) and generating inspection data accordingly. The electromagnetic radiation 10 includes X-rays.

### TECHNICAL FIELD

This invention relates to a method and a device for inspecting an object made of plastic material and including at least one layer to be inspected.

### BACKGROUND ART

Prior art methods for inspecting plastic objects include methods that comprise positioning the object in an inspection zone where the object is irradiated by electromagnetic radiation emitted by an emitter.

These methods involve using a sensor to detect an absorption of the electromagnetic radiation by the layer to be inspected. The sensor generates a corresponding absorption signal, which is processed in a control unit to generate inspection data representing physical parameters of the layer to be inspected.

More specifically, prior art solutions like the one described in document EP2605004B1 teach the use of electromagnetic radiation in the infrared spectrum, emitted or absorbed by the layer to be inspected as a function of the temperature of the layer to be inspected.

These methods, however, are limited to determining only some of the parameters of the inspected layer: for example, its thickness. These methods cannot be used to determine either the composition or the density of the material the layer is made of. In particular, even the thickness cannot be determined without first knowing the composition.

Other examples of inspection methods and inspection devices for plastic objects are described in the following patent documents: EP1801536A1 and DE102018204793A1.

### DISCLOSURE OF THE INVENTION

This invention has for an aim to provide an inspection method and device to overcome the above mentioned disadvantages of the prior art.

This aim is fully achieved by the method and device of this disclosure as characterized in the appended claims.

According to an aspect of it, this disclosure provides a method for inspecting an object, preferably an object made of plastic material. The object comprises at least one layer to be inspected.

The method comprises a step of positioning the object in an inspection zone. The method comprises a step of irradiating the inspection zone. The irradiation is performed by electromagnetic rays emitted by an emitter. The method comprises a step of detecting with a sensor an absorption of the electromagnetic radiation by the layer to be inspected.

The method comprises a step of generating an absorption signal representing the absorption of the electromagnetic radiation by the layer to be inspected.

The method comprises a step of processing the absorption signal in a control unit.

The method comprises a step of generating inspection data based on the processing of the absorption signal.

In an embodiment, in the step of irradiating, the electromagnetic radiation includes X-rays.

In an embodiment, the object is a multilayer object. In other words, besides the layer to be inspected, the object includes an additional layer.

In an embodiment, the inspection data include one or more of the following quantities:
thickness of the layer to be inspected;
density of the layer to be inspected;
composition of the layer to be inspected.

In an embodiment, the method comprises a step of configuring. In the step of configuring, the control unit receives reference data representing a reference absorption signal. In the step of configuring, the control unit saves the reference data to a memory. The inspection data are preferably generated as a function of a comparison between the absorption signal and the reference data (the reference absorption signal).

In an embodiment of the method, in the step of detecting, the sensor detects a number of X photons greater than 20000, preferably greater than 30000.

In an embodiment of the method, in the step of detecting, the sensor captures data at a sampling speed of less than 20 Hz.

In an embodiment of the method, in the step of detecting, the sensor captures data at a sampling speed of less than 30 Hz.

In an embodiment of the method, in the step of detecting, the sensor captures data at a sampling speed of between 5 and 25 Hz.

In an embodiment of the method, in the step of detecting, the emitter emits a plurality of X-rays. In an embodiment, the plurality of X-rays defines a linear X-ray. In an embodiment, the plurality of X-rays defines a planar X-ray: that is, a matrix of X-rays.

In an embodiment of the method, the method comprises an additional step of detecting. In the additional step of detecting, an additional sensor detects an absorption of the X-rays by the inspected layer. The additional sensor generates an additional absorption signal, representing the absorption of the rays by the inspected layer. In this embodiment, the control unit generates the inspection data in response to the absorption signal and/or the additional absorption signal.

In an embodiment, the object is a singulated product. Alternatively, the object to be inspected is defined by (consists of) a continuous flow of material traversing the inspection zone.

In an embodiment, the method comprises a step of synchronizing. In the step of synchronizing, the control unit synchronizes the emitter with a traversing speed of the object (that is, the speed at which the object goes through the inspection zone) to inspect predetermined zones of the object.

According to an aspect of it, this disclosure provides a device for inspecting an object, preferably an object made of plastic material and including at least one layer to be inspected.

The device comprises an inspection zone in which the object to be inspected is operatively positioned. The device comprises an emitter, configured to irradiate the inspection zone with electromagnetic radiation.

The device comprises a sensor, configured to generate an absorption signal representing an absorption of the electromagnetic radiation absorbed by the layer to be inspected.

The device comprises a control unit configured to receive the absorption signal from the sensor. The control unit is programmed to process the absorption signal to derive inspection data. Inspection data represent properties of the object to be inspected (of the layer to be inspected).

In an embodiment, the electromagnetic radiation includes X-rays.

In an embodiment, the inspection data include one or more of the following parameters: a thickness of the inspected layer, a density of the inspected layer or a composition of the inspected layer.

The control unit has access to reference data, representing a predetermined (or reference) absorption signal. The control unit is programmed to calculate the inspection data in response to a comparison between the absorption signal and the reference data.

In an embodiment, the sensor comprises silicon and CZT, a compound of cadmium, zinc and tellurium.

In an embodiment, the device comprises an additional sensor. The additional sensor is configured to detect an absorption of the ray by the inspected layer. The additional sensor is configured to generate an additional absorption signal, representing the absorption of the ray by the inspected layer. In an embodiment, the control unit is configured to derive the inspection data in response to the absorption signal and/or the additional absorption signal.

The control unit is configured to synchronize the emitter with a traversing speed at which the object goes through the inspection zone, to inspect predetermined zones of the object.

We observe that, in at least one example, the inspected object moves along a (predetermined) path (trajectory). The object is inspected during the movement of the object along its path. Hence, in this example the device is located at an inspection location on the path. In particular, the object may be moved with a continuous advancement (for example through a rotary machine, i.e. a machine provided with a rotating wheel for moving a plurality of objects) or with an intermittent advancement (for example in machines which are known as indexed).

In case of machine with continuous advancement of the objects, an advancement speed is defined (which can be constant or variable). In case of machine with intermittent advancement of the objects, an advancement speed of the object and a stationary interval of the objects can be defined.

Generally speaking, the device is configured to carry out a plurality of acquisition in succession, at a predetermined rate (while the object is positioned in the inspection location).

According to an example, the device includes a regulator for adjusting the detection rate; likewise, the method includes a step of adjusting the detection (acquisition) rate. This allows to ensure that the information gathered through detection are complete and accurate, even if the speed at which the objects are moved along the advance path increases; more generally, it allows you to adapt and optimize the acquisition to the speed of movement of the objects.

Indeed, in order to obtain a reliable and precise inspection, the number of photons detected by the inspection device is included in a predetermined interval. Thus, to detect the correct number of photons, it is possible to regulate the number of photons emitted over time or the stationary time of the object in the inspection zone. In this regard, the control unit is programmed to synchronize the emitter with the advancement speed of the object in the embodiment wherein the object advances continuously. Moreover, the control unit is programmed to synchronize the emitter with one or more of the following:
the advancement speed of the object, in the embodiment wherein the object advances intermittently, such that the inspection is run in the right instant;
the stationary interval, such that it is guarantee an optimal number of photons to obtain on optimal inspection.

In other words, the control unit is programmed to regulate the advancement speed and/or the emission frequency of the emitter such that a predetermined number of photons is detected.

It is further observed that, as the advancement speed increase, the emission frequency of the emitter is higher. On the other hand, if the advancement speed increases (or the stationary interval gets longer), the control unit may programmed to reduce (automatically) the detection frequency.

In an embodiment, the sensor is configured to detect a number of X photons greater than 20000, preferably greater than 30000.

In an embodiment, the sensor is configured to capture data at a sampling speed of less than 20 Hz.

In an embodiment, the emitter is configured to emit a plurality of X-rays. In an embodiment, the plurality of X-rays defines a linear X-ray. In an embodiment, the plurality of X-rays defines a planar X-ray: that is, a matrix of X-rays.

The present disclosure regards also a machine for manufacturing plastic objects; examples of such a machine are a molding machine (either compression or injection molding) for manufacturing preforms or closures for plastic bottles, or a blow molding machine, for forming containers from the preforms. The present disclosure also regards a line for the production, in continuous cycle, of plastic objects; the line may for example include one or more of the machines mentioned above. In the machine (or in the line), the plastic objects are movable along a path (advancing path). The device according to the present disclosure (e.g. the device having one or more of the features included in the present disclosure) can be included in said machine or in said line.

### BRIEF DESCRIPTION OF DRAWINGS

These and other features will become more apparent from the following description of a preferred embodiment, illustrated by way of non-limiting example in the accompanying drawings, in which:

FIG. 1 schematically illustrates a device for inspecting an object made of plastic material;

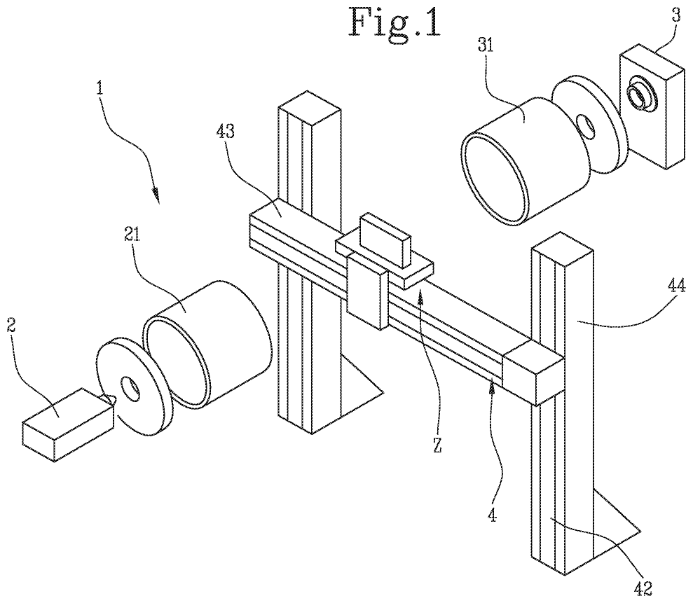

FIG. 2 schematically illustrates a sensor of the device of FIG. 1;

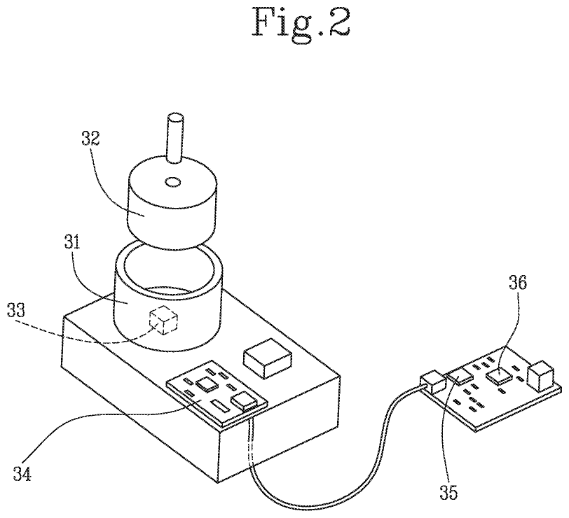

FIG. 3 is a schematic side view of the device of FIG. 1;

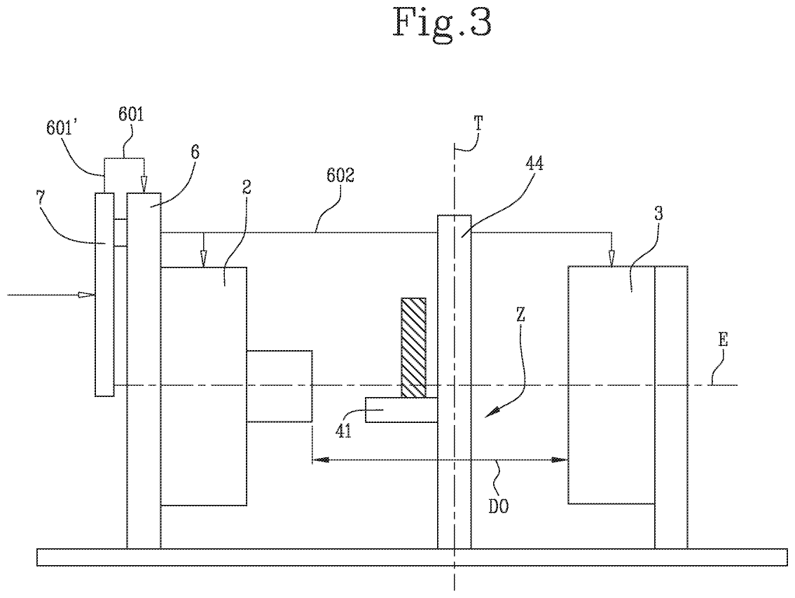

FIG. 4 is a schematic plan view of the device of FIG. 1.

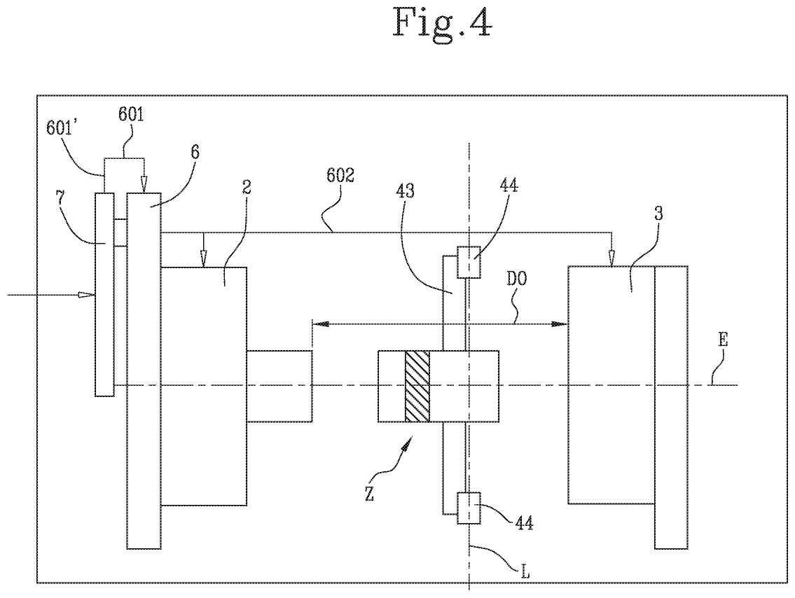

### DETAILED DESCRIPTION OF PREFERRED EMBODIMENTS OF THE INVENTION

With reference to the accompanying drawings, the numeral 1 denotes a device for inspecting an object, which is preferably made of plastic material. The device can, however, also be used to inspect ceramic material or organic material such as wood or cellulose.

In an embodiment, the device 1 comprises an emitter 2, configured to emit electromagnetic radiation. The electromagnetic radiation comprises an X-ray. The emitter 2 comprises a source which emits the X-ray. In an embodiment, the X-ray is a hyperspectral X-ray. In an embodiment, the source is a polychrome source.

The emitter 2 is configured to emit the X-ray in an emission axis E. The X-ray emitted strikes the object to be inspected, which attenuates the X-ray as a function of the characteristic parameters of the material.

In an embodiment, the emitter 2 comprises an alignment tube 21, extending along the emission direction E, to align the X-ray with the emission axis E.

The device 1 comprises a sensor 3. The sensor 3 is configured to detect the X-ray emitted by the emitter 2. The sensor 3 is aligned with the emitter 2 along the emission axis E.

The sensor 3 is preferably a spectroscopic sensor. For each photon of the X-ray that strikes it, the sensor 3 is configured to determine a corresponding energy of the photon. In other words, the sensor 3 is configured to work in single photon counting mode.

In an embodiment, the sensor 3 comprises one or more of the following features:
an alignment tube 31, extending along the emission axis E;
a collimator 32, disposed on the bottom of the alignment tube to collimate the X-rays received by the sensor 3;
a sensitive element 33, preferably a CTZ spectrometer, configured to generate an absorption signal 301 based on the X-rays (on the photons) that strike it;
a pre-amplifier 34, connected to the sensitive element 33 to receive and amplify the absorption signal 301;
a digitizer 35, configured to digitize the absorption signal 301;
a processor 36, configured to process the absorption signal 301. The processor 36 is preferably a field programmable gate array (FPGA).

Preferably, the sensitive element 33 is planar. The sensitive element 33 is disposed inside the alignment tube 31, downstream of the collimator 32 along the emission axis E in the direction of receiving the X-ray.

In an embodiment, the emitter 2 and the sensor 3 are spaced along the emission direction E by an operating distance DO, which is less than 50 cm. In an embodiment, the operating distance DO is less than 40 cm, preferably less than 30 cm.

In an embodiment, the device 1 comprises a supporting unit 4. The supporting unit 4 is configured to hold the inspected object during X-ray emission.

In an embodiment, the supporting unit 4 is configured to move the object along a movement plane PA, perpendicular to the emission direction. More specifically, in an embodiment, the supporting unit 4 is configured to move the object along a longitudinal direction and along a transverse direction T, which are perpendicular to each other and both of which are perpendicular to the emission axis E.

The supporting unit 4 comprises a support 41 configured to hold the object while it is being inspected.

The supporting unit 4 comprises a drive actuator 42. The drive actuator 42 is configured to move the support 41 along the movement plane PA.

More specifically, in an embodiment, the supporting unit 4 comprises a longitudinal beam 43, extending along the longitudinal direction L. The supporting unit 4 comprises one or more transverse beams 44, extending along the transverse direction T.

The longitudinal beam 43 is movable on the one or more transverse beams 44 to vary its position along the transverse direction T. The support 41 is movable along the longitudinal beam 43 to vary its position along the longitudinal direction L. That way, while keeping the emitter 2 at a fixed position, all parts of the object to be inspected can be irradiated by moving the object with the supporting unit 4.

In an embodiment, the device 1 comprises a control unit 6. In an embodiment, the device 1 comprises a user interface 5 to allow a user to interact with the control unit 6 and with the device 1.

The control unit 6 is connected to the supporting unit 4 and/or to the emitter 2 and/or to the sensor 3. The control unit 6 is configured to receive configuration data 601, representing configuration parameters of the device 1. For example, but not necessarily, the configuration data 601 comprise reference data 601′, representing a reference absorption signal, and operating data, representing one or more of the following parameters:
type of X-ray to be emitted;
energy of the X-ray to be emitted;
inspection position on the object to be inspected.

The control unit 6 is configured to generate command signals 602 based on the configuration data 601.

More specifically, the control unit 6 is configured to send the command signals 602 to the supporting unit 4, to instruct it where to position the inspected object relative to the emission axis E. More specifically, the control unit 6 is configured to send the command signals 602 to the emitter 2 to instruct it as to the emission of X-rays. More specifically, the control unit 6 is configured to send the command signals 602 to the sensor 3 to command it to detect the X-ray.

It should be observed that the attenuation of the X-ray by an object having a mass m is given by the following formula:

$$ln ( \frac{Io ( E )}{I ( E )} ) = ρ * t * {\sum }_{i} {w}_{i} * {μ}_{{m}_{i}} ( E )$$

Where Io(T) is a value of reference energy intensity, on which the device 1 is calibrated, I(E) is the value of energy intensity of the incident photons of the X-ray detected by the sensor 3, ρ is the density of the object irradiated by the X-ray, t is a thickness of the object irradiated by the X-ray, while Σₗwₗ*μₘ_{ᵢ}(E) is the sum of the products of the mass fraction wₗ of each component element of the object multiplied by the respective attenuation coefficient μₘ_{ᵢ}(E). The value of reference energy intensity can be determined (is associated with, can be calculated) from the reference data 601′ received from the control unit 6.

That means the X-ray attenuation depends on the thickness, the density and the physical and chemical composition of the object to be inspected.

That said, if at least two of the above parameters are known, the device 1 allows determining the third parameter.

In an embodiment, therefore, the device 1 is configured to determine a thickness of a layer of material of the object and/or a density of the layer to be inspected and/or its chemical composition. In such a case, the control unit 6 is configured to receive material data, representing a density value of the layer to be inspected and/or the chemical composition of the layer to be inspected (or the value of the resultant attenuation coefficient) and/or the thickness of the layer to be inspected.

In an embodiment, the configuration data 601 also comprise an indication as to an operating configuration with which to operate the device 1. More specifically, purely by way of example, the user interface 5 allows entering the indication, which is variable between:
a thickness configuration, in which the control unit is configured to determine a thickness of the inspected layer from the density value and from the resultant attenuation coefficient value of the inspected layer;
an absolute density configuration, in which the control unit is configured to determine an absolute density of the inspected layer from the thickness value and from the resultant attenuation coefficient value of the inspected layer;
a composition configuration, in which the control unit is configured to determine a chemical and physical composition of the inspected layer from the density value and from the thickness value of the inspected layer.

In an embodiment, it is possible to determine both the absolute density and the mass percentage of each element of the layer to be inspected, if the other parameters of the formula are known.

In an embodiment, the configuration data 601 may include one or more of the following parameters:
incident X-ray flux;
capture spectrum;
speed of sampling and photon capture on the sensor 3;
X-ray flux energy range;
collimator aperture value;
distances between sensor 3, emitter 2 and supporting unit 4;

Further, in an embodiment, the relative position between the sensor 3, the emitter 2 and the supporting unit along the emission axis E is adjustable. According to an aspect of it, this disclosure provides a method for inspecting an object, preferably an object which may be made of plastic material but also of ceramic material and/or organic material (wood).

The method is preferably a method for determining a thickness of a layer of an object that is preferably a multilayer object which, besides the layer to be inspected, also includes an additional layer. The method is performed by a device 1 for inspecting an object according to this disclosure.

The method comprises positioning the object to be inspected in an inspection zone Z of the device 1, where it can be reached by electromagnetic radiation.

The method comprises a step of irradiating (emitting), in which an emitter 2 emits electromagnetic radiation which preferably comprises an X-ray. Preferably, in the step of irradiating, a polychrome source of the emitter 2 emits an X-ray, preferably a hyperspectral X-ray.

The emitter 2 emits the X-ray along an emission axis E. The X-ray is attenuated by the presence of the object, which has a resultant attenuation coefficient deriving from the attenuation coefficient of the single component elements. The part of the material that contributes to the attenuation is the part that is effectively traversed by the X-ray.

In an embodiment, the step of irradiating comprises a plurality of emissions, each associated with a respective inspection point on the object.

In the step of positioning, the object is positioned in such a way that the inspected layer is perpendicular to the X-ray, so as to calculate a thickness of the inspected layer in a direction parallel to the emission axis E.

In an embodiment, the step of irradiating comprises a step of aligning in which an alignment tube 21 of the emitter 2 aligns the X-ray with the emission axis E.

The method comprises a step of detecting, in which a sensor 3, preferably a spectroscopic sensor, detects the X-ray emitted by the emitter 2 and attenuated by the object to be inspected. The sensor 3 is aligned with the emitter 2 along the emission axis E. For each photon of the X-ray that strikes it, the sensor 3 determines a corresponding energy of the photon. In other words, the sensor 3 works in “single photon counting mode”.

In an embodiment, the step of detecting comprises one or more of the following steps:
aligning the X-ray along the emission axis E;
collimating with a collimator 32 the X-rays received by the sensor 3;
detecting with a sensitive element 33, preferably a CTZ spectrometer, and generating an absorption signal 301 based on the X-rays (on the photons) that strike it;
amplifying with a pre-amplifier 34, connected to the sensitive element 33 to receive the absorption signal 301;
digitizing the absorption signal 301 with a digitizer 35;
processing the absorption signal 301 with a processor 36, preferably a field programmable gate array (FPGA).

In an embodiment, the method comprises a step of supporting. In the step of supporting, a supporting unit 4 holds the inspected object during X-ray emission.

In an embodiment, the supporting unit 4 moves (drives) the object along a movement plane PA, perpendicular to the emission direction. More specifically, in an embodiment, the supporting unit 4 moves (drives) the object along a longitudinal direction and along a transverse direction T, which are perpendicular to each other and both of which are perpendicular to the emission axis E.

The supporting unit 4 comprises a support 41 which holds the object while X-rays are being emitted to inspect it.

In an embodiment, the step of supporting comprises a step of driving, in which a drive actuator 42 moves the support 41 along the movement plane PA.

In the step of driving, a longitudinal beam 43 of the supporting unit 4 moves along one or more transverse beams 44. In the step of driving, the support 41 moves along the longitudinal beam 43.

In an embodiment, the method comprises a step of controlling, in which a control unit 6 controls the emitter 2, the sensor 3 and the supporting unit 4. In an embodiment, the method comprises a step of configuring, in which the control unit receives, through a user interface 5, configuration data 601, representing configuration parameters of the device 1.

For example, but not necessarily, the configuration data 601 comprise reference data 601′, representing a reference absorption signal, and operating data, representing one or more of the following parameters:
type of X-ray to be emitted;
energy of the X-ray to be emitted;
inspection position on the object to be inspected.

The control unit 6 generates command signals 602 based on the configuration data 601.

More specifically, the control unit 6 sends the command signals 602 to the supporting unit 4, to instruct it where to position the inspected object relative to the emission axis E. More specifically, the control unit 6 sends the command signals 602 to the emitter 2 to instruct it as to the emission of X-rays. More specifically, the control unit 6 sends the command signals 602 to the sensor 3 to command it to detect the X-ray.

Based on the absorption signal, the control unit 6 calculates a thickness of the layer to be inspected, a density of the layer to be inspected and a mass percentage of the elements making up the layer to be inspected. The calculation is based on the following formula:

$$ln ( \frac{Io ( E )}{I ( E )} ) = ρ * t * {\sum }_{i} {w}_{i} * {μ}_{{m}_{i}} ( E )$$

Where Io(E) is a value of reference energy intensity, on which the device 1 is calibrated, I(E) is the value of energy intensity of the incident photons of the X-ray detected by the sensor 3, ρ is the density of the object irradiated by the X-ray, t is a thickness of the object irradiated by the X-ray, while Σᵢwᵢ*μₘ_{ᵢ}(E) is the sum of the products of the mass fraction w of each component element of the object multiplied by the respective attenuation coefficient μₘ_{ᵢ}(E).

The control unit determines the value of reference energy intensity from the reference data 601′ received from the control unit 6.

That said, if at least two of the above parameters are known, the device 1 allows determining the third parameter.

In an embodiment, therefore, the device 1 determines a thickness of a layer of material of the object and/or a density of the layer to be inspected and/or its chemical composition. In such a case, the control unit 6 receives material data, representing a density value of the layer to be inspected and/or the chemical composition of the layer to be inspected (or the value of the resultant attenuation coefficient) and/or the thickness of the layer to be inspected.

In an embodiment, the method comprises a step of re-configuring the device 1, in which the control unit 6 receives an indication as to an operating configuration with which to operate the device 1.

The method thus offers the possibility of implementing one of the following configurations:
a thickness configuration, in which the control unit determines a thickness of the inspected layer from the density value and from the resultant attenuation coefficient value of the inspected layer;
an absolute density configuration, in which the control unit determines an absolute density of the inspected layer from the thickness value and from the resultant attenuation coefficient value of the inspected layer;
a composition configuration, in which the control unit determines a chemical and physical composition of the inspected layer from the density value and from the thickness value of the inspected layer. The latter aspect is possible in that knowing the elements included in the layer to be inspected and knowing the attenuation coefficient of the specific elements allow determining the mass percentage of each element: for example, using the “least square best fit” method.

In an embodiment, it is possible to determine both the absolute density and the mass percentage of each element of the layer to be inspected, if the other parameters of the formula are known.

In an embodiment, in the step of configuring, the control unit receives one or more of the following parameters:
incident X-ray flux;
capture spectrum;
speed of sampling and photon capture on the sensor 3;
X-ray flux energy range;
collimator aperture value;
distances between sensor 3, emitter 2 and supporting unit 4;

In an embodiment, the method comprises a step of adjusting the relative position between the sensor 3, the emitter 2 and the supporting unit 4. In the step of adjusting, an adjustment actuator moves the sensor 3 relative to the emitter 2. Further, in an embodiment, the drive actuator 42 is configured to move the support 41 along the emission axis E. More specifically, the supporting unit may also comprise an adjustment beam, parallel to the emission axis E, on which the support 41 is movable towards or away from the emitter 2.

It should be noted that in an embodiment in which the device 1 comprises a plurality of emitters and a corresponding plurality of sensors, the method comprises a plurality of steps of emitting and a corresponding plurality of steps of detecting, each associated with a respective X-ray which strikes a specific point of the object to be inspected. A full inspection of the layer can therefore be performed either by varying the relative position between the object and the emitter 2/sensor 3 unit along the movement plane PA or by multiplying the number of emitter 2/sensor 3 units.

Through the plurality of steps of emitting, the X-ray may have a linear or a planar shape. This reduces the influence of non-uniformity of the parameter being detected along the longitudinal direction L or the transverse direction T. This non-uniformity would not be detected if a single point of the material were inspected.

In an embodiment of the method, the object is a singulated product. In an embodiment, the object to be inspected consists of a continuous flow of material traversing the inspection zone. In the latter embodiment, the method comprises a step of synchronizing, in which the step of emitting is synchronized with the flow of material in the inspection zone, so as to correctly coordinate the emission of the ray with the inspection of a predetermined position of the object.

According to an aspect of the present disclosure, the object is movable on a path with an advance speed (for example within a machine or a line for manufacturing the plastic objects). In this example, the inspection zone is located on the path. The device 1 (the control unit of the device 1) has knowledge of the advance speed. The control unit is programmed to regulate one or more of the following aspects (parameters or variables):
an intensity of the electromagnetic radiation emitted by the emitter 2;
a duration of an inspection time interval, wherein the object remains in the inspection zone;
a detection rate, wherein the control unit carries out through the sensor 3 a plurality of detections at the detection rate, during the inspection time interval.

For example, the control unit is programmed to perform said regulation (automatically), on the basis (as a function) of the advance speed of the objects.

Likewise, the method according to the present disclosure may comprise a step of regulating (through the control unit) one or more of the following aspects:
an intensity of the electromagnetic radiation emitted by the emitter 2;
a duration of an inspection time interval, wherein the object remains in the inspection zone;
a detection rate, wherein the control unit carries out through the sensor 3 a plurality of detections at the detection rate, during the inspection time interval.

The regulating step may be carried out (automatically), on the basis (as a function) of the advance speed of the objects.

1.-17. (canceled)

18. A method for inspecting an object, where the object is made of plastic material and includes at least one layer to be inspected, the method comprising the following steps:
positioning the object in an inspection zone;
irradiating the inspection zone with electromagnetic radiation emitted by an emitter;
detecting, with a sensor, an absorption of the electromagnetic radiation by the layer to be inspected and accordingly generating an absorption signal representing the absorption of the electromagnetic radiation by the layer to be inspected;
processing the absorption signal in a control unit and generating inspection data accordingly,
wherein the electromagnetic radiation includes X-rays.

19. The method according to claim 18, wherein the object is a multilayer object and, besides the layer to be inspected, includes an additional layer.

20. The method according to claim 18, wherein the inspection data include one or more of the following quantities:
thickness of the layer to be inspected;
density of the layer to be inspected;
composition of the layer to be inspected.

21. The method according to claim 18, comprising a step of configuring, in which the control unit receives and saves to a memory reference data, representing a reference absorption signal, and wherein the inspection data are generated as a function of a comparison between the absorption signal and the reference data.

22. The method according to claim 18, wherein in the step of irradiating, the emitter emits a plurality of X-rays to form a linear X-ray or a planar X-ray.

23. The method according to claim 18, comprising an additional step of detecting, in which an additional sensor detects an absorption of the X-rays by the layer to be inspected and generates an additional absorption signal representing the absorption of the rays by the inspected layer, and wherein the control unit generates the inspection data in response to the absorption signal and the additional absorption signal.

24. The method according to claim 18, wherein the object is a singulated product or consists of a portion of a continuous flow of material traversing the inspection zone.

25. The method according to claim 18, comprising a step of synchronizing, in which the control unit synchronizes the emitter with a traversing speed at which the object goes through the inspection zone to inspect predetermined zones of the object.

26. The method according to claim 18, wherein the object moves on a path with an advance speed, the inspection zone being located on the path, and wherein the control unit regulates one or more of the following aspects, on the basis of the advance speed:
an intensity of the electromagnetic radiation emitted by the emitter;
a duration of an inspection time interval, wherein the object remains in the inspection zone;
a detection rate, wherein the control unit carries out through the sensor a plurality of detections at the detection rate, during the inspection time interval.

27. A device for inspecting an object made of plastic material and including at least one layer to be inspected, the device comprising:
an inspection zone, in which the object to be inspected is operatively positioned;
an emitter, configured to irradiate the inspection zone with electromagnetic radiation;
a sensor, configured to generate an absorption signal representing an absorption of the electromagnetic radiation absorbed by the layer to be inspected;
a control unit configured to receive the absorption signal from the sensor and programmed to process the absorption signal to derive inspection data,
wherein that the electromagnetic radiation includes X-rays.

28. The device according to claim 27, wherein the inspection data include one or more of the following parameters: a thickness of the inspected layer, a density of the inspected layer or a composition of the inspected layer.

29. The device according to claim 27, wherein the control unit has access to reference data, representing a predetermined absorption signal and is programmed to calculate the inspection data in response to a comparison between the absorption signal and the reference data.

30. The device according to claim 27, wherein the sensor comprises silicon and CZT, a compound of cadmium, zinc and tellurium.

31. The device according to claim 27, comprising an additional sensor, configured to detect an absorption of the ray by the inspected layer and to generate an additional absorption signal representing the absorption of the ray by the inspected layer, and wherein the control unit is configured to derive the inspection data in response to the absorption signal and the additional ab sorption signal.

32. The device according to claim 27, wherein the control unit is configured to synchronize the emitter with a traversing speed at which the object goes through the inspection zone to inspect predetermined zones of the object.

33. The device according to claim 27, wherein the control unit has knowledge of an advance speed, the object being movable on a path with the advance speed and the inspection zone being located on the path, and wherein the control unit is programmed to regulate one or more of the following aspects, on the basis of the advance speed:
an intensity of the electromagnetic radiation emitted by the emitter;
a duration of an inspection time interval, wherein the object remains in the inspection zone;
a detection rate, wherein the control unit carries out through the sensor a plurality of detections at the detection rate, during the inspection time interval.

34. A line for manufacturing in continuous cycle plastic objects, the line comprising:
a machine for processing plastics;
a device for inspecting the objects processed in the line, each object being made of plastic material and including at least one layer to be inspected, wherein the device comprises:
an inspection zone, in which the object to be inspected is operatively positioned;
an emitter, configured to irradiate the inspection zone with electromagnetic radiation;
a sensor, configured to generate an absorption signal representing an absorption of the electromagnetic radiation absorbed by the layer to be inspected;
a control unit configured to receive the absorption signal from the sensor and programmed to process the absorption signal to derive inspection data,
wherein that the electromagnetic radiation includes X-rays.

35. The line according to claim 34, wherein the control unit has knowledge of an advance speed, the object being movable on a path with the advance speed and the inspection zone being located on the path, and wherein the control unit is programmed to regulate one or more of the following aspects, on the basis of the advance speed:
an intensity of the electromagnetic radiation emitted by the emitter;
a duration of an inspection time interval, wherein the object remains in the inspection zone;
a detection rate, wherein the control unit carries out through the sensor a plurality of detections at the detection rate, during the inspection time interval.

36. The line according to claim 34, wherein the control unit synchronizes the emitter with a traversing speed at which the object goes through the inspection zone to inspect predetermined zones of the object.

37. The line according to claim 34, wherein the object is a singulated products or consists of a portion of a continuous flow of material traversing the inspection zone.
